(19) United States
(12) Patent Application Publication
(10) Pub. No.: US 2007/0185698 A1
(43) Pub. Date: Aug. 9, 2007

(54) Configuration of a risk detection system

(75) Inventors: Rosa Maria Ferrer Vilardell, Zurich (CH); Andreas Huber, Schaffhausen (CH); Axel Kunze, Zurich (CH)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/549,521

(22) Filed: Oct. 13, 2006

(30) Foreign Application Priority Data
Oct. 13, 2005 (EP) EP05109533

(51) Int. Cl. G06F 17/50; G06N 5/00; G08B 29/00; G08B 17/10

(52) U.S. Cl. 703/13; 706/45; 340/506; 340/628

(57) ABSTRACT

In a risk detection system having at least one element to be configured, a configuration procedure with at least two configuration steps is created for an element of the risk detection system to be configured. The validity of an entry of at least one item of information is examined in a configuration operation of the configuration procedure for the element to be configured.

### CROSS REFERENCE TO RELATED APPLICATIONS

This application is based on and hereby claims priority to European Application No. EP05109533 filed on Oct. 13, 2005, the contents of which are hereby incorporated by reference.

### BACKGROUND

Described below are a method and a device for configuring a fire protection system comprising at least one element to be configured.

Risk detection systems, such as detection systems for fire, gas, temperature etc. comprise mostly detectors which are connected to a control center. Such risk detection systems are used in public buildings, office blocks, hotels, industrial buildings, airports, stations, workshops, schools etc. If an alarm is triggered on one of the detectors, the control center is notified. The functions of the control center can be freely parameterized and support an alarm organization adjusted to the object to be monitored. Such control centers mostly exhibit an integrated control element with a graphical display and interfaces to communication networks. Such a control center must be set up and configured prior to start-up. The language to be used, the national standards and specifications, the detectors used, the quantity and parameterization of the detectors, the characteristics and the hardware of the risk detection center are hereby configured and/or adapted.

### SUMMARY

an aspect of involves proposing the simplest and most cost-effective option possible for configuring risk detection systems.

A core feature is creating a configuration procedure for an element of the risk detection system to be configured and in examining the validity of the entry when entering at least one item of information in a configuration operation of the configuration procedure. An item of information can here represent a parameter, an address, a digit, an alphanumeric character etc. In accordance with the disclosed method, at least one item of information can be entered in a next configuration operation of the configuration procedure only if the examination of the validity of the entry of the at least one item of information in a previous configuration operation is positive, i.e. only when the entry is valid and/or plausible can at least one item of information be entered in the next configuration operation. The next configuration operation means a configuration operation of the element to be configured. The following configuration operation need thus not be configured as the next one. This can then be of interest if only a basic configuration, which is required for instance for a first start-up of the risk detection system, is to be configured. It is conceivable in accordance with the disclosed method that the entries in the individual configuration steps of the configuration procedure are independent of one another. This means that an entry can be carried out in a next configuration step, even when the examination of the validity is negative. The hardware, the detection, the monitoring, the characteristics of the risk detection system etc. are viewed as elements to be configured of the risk detection system. A configuration procedure can be displayed as a tree, table, detail editor etc.

One advantage of the method is being able to configure a risk detection system in a rapid, simple and cost-effective manner.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a hierarchical diagram for an example of the creation of a configuration procedure, and

FIG. 2 is a block diagram of a device described below.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

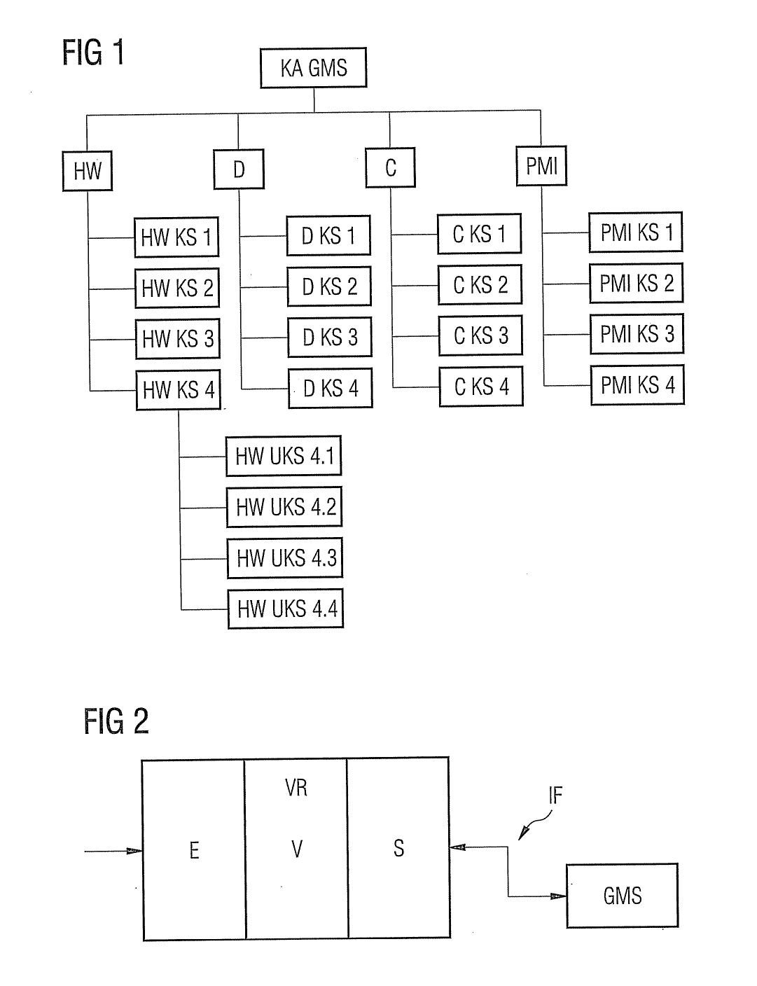

FIG. 1 shows an example of the creation of a configuration procedure KA GMS for a risk detection system GMS. The example shows a tree, but a table, a detail editor etc. could also be used for display purposes. With the elements to be configured, hardware HW, detection D, monitoring C and characteristics PMI of the risk detection system, configuration steps KS are defined for configuring these elements. In this example, only four configuration steps KS are displayed for a better overview. In accordance with the disclosed method, the number of configuration steps is however not limited. In accordance with the disclosed method, subsidiary configuration steps UKS, such as subsidiary to configuration operation HW KS 4, can naturally be conceived. A configuration procedure created and defined in this manner can contain rules for configuring the risk detection control center. Rules can cover formats, specifications, standards, languages, parameters of the detectors etc. When at least one item of information is entered in a configuration step, the rule and/or the rules are compared with the entry and thus the validity for a configuration is examined. A configuration comprises entered items of information which take standards, specifications, languages, customer demands etc. into consideration. If the validity is positive, i.e. the entry is valid and plausible, an entry can be made for the next configuration step. Otherwise, an error message could be displayed. It is naturally possible in accordance with the disclosed method for configuration operations to be skipped.

FIG. 2 shows a device VR with a receive unit E, a processing unit V and a transmit unit S. This device VR can be connected to the risk detection system GMS via an interface IP. It is naturally just as possible for the device to be integrated into the risk detection system. Such a device can comprise an entry device for entering alphanumeric characters, a monitor for displaying the configuration procedure, the already mentioned processing unit V, the receive unit for receiving information from the risk detection system GMS or from a unit in a communication network and a transmit unit for transmitting items of information. Generally, a computer, a mobile computer, a PDA, a mobile radio device etc could be used as device VR and integrated into the risk detection system GMS.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for configuring a risk detection system having at least one element to be configured, comprising:
creating a configuration procedure with at least two configuration operations for an element to be configured in the risk detection system; and
examining validity of an entry of at least one first item of information in a configuration operation of the configuration procedure for the element to be configured.

11. A method according to claim 10, further comprising permitting at least one second item of information to be entered during a next configuration operation of the configuration procedure only if said examining of the validity of the entry of the at least one first item of information in a preceding configuration step is positive.

12. A method according to claim 10, further comprising entering at least one further item of information in a next configuration operation of the configuration process independently of the entry of the at least one first item of information in the configuration operation.

13. A method according to claim 12, wherein the at least one element to be configured in the risk detection system includes at least one of a hardware element, a detection element, a monitoring element and a characteristic element.

14. A method according to claim 13, further comprising displaying the configuration process as at least one of a tree, a table and a detail editor.

15. A method according to claim 14, wherein the at least one first and second items of information include at least one of a parameter, an address, a digit and an alphanumeric character

16. A device for configuring a risk detection system having at least one element to be configured, comprising:
a receive unit and a transmit unit communicating with at least one user; and
a processing unit creating a configuration procedure for an element to be configured in the risk detection system, with at least two configuration operations, by entering at least one item of information during a first configuration operation and examining validity of the entry of the at least one item of information in a second configuration operation of the configuration procedure for the element to be configured.

17. A device according to claim 16, wherein said device is connected to the risk detection system via an interface.

18. A device according to claim 17, wherein said device is one of a computer, a mobile computer and a mobile radio.
